(19) United States
(12) Patent Application Publication
(10) Pub. No.: US 2004/0099453 A1
(43) Pub. Date: May 27, 2004

(54) Lift truck with coast mode of operation and indicator

(76) Inventor: Douglas S. Guy, Brantford (CA)

Correspondence Address: QUARLES & BRADY LLP, 411 E. WISCONSIN AVENUE, SUITE 2040, MILWAUKEE, WI, 53202-4497, US

(21) Appl. No.: 10/304,439

(22) Filed: Nov. 26, 2002

(51) Int. Cl. B62D 51/04; B60K 1/00

(52) U.S. Cl. 180/65.1; 180/19.3

(57) ABSTRACT

A motorized lift truck includes a coast mode of operation in which the vehicle can be operated while the operator walks alongside the vehicle. The coast mode can be activated from either of a walking or a riding position. An indicator device, such as an indicator light, is provided to alert the operator when the lift truck is operated in the coast mode.

### FIELD OF THE INVENTION

The present invention relates to material handling vehicles and, more particularly, to a material handling vehicle including a mode of operation indicator.

### BACKGROUND OF THE INVENTION

Industrial material handling vehicles such as lift trucks or pallet trucks are commonly found in warehouses, factories, shipping yards, and, generally, wherever pallets, packages, or loads of goods are required to be moved from place to place. Lift or pallet trucks typically include a load bearing fork or lift arm for lift and transporting packages or pallets, an electric traction motor for driving the vehicles, a steering control mechanism, and a brake. The steering mechanism for a common type of pallet truck includes a handle mounted at the end of a movable arm and includes rotatable twist grips that control the speed and direction of the truck in both forward and reverse directions, as well as controls for raising and lowering the fork. To prevent movement of the truck when the operator has left the vehicle, material handling vehicles of this type often also include a spring-applied “deadman” brake mechanism which is activated by a spring force applied to the handle, typically whenever the operator releases control of the handle. When the handle is released, it is forced by the spring to a near vertical position outside of a defined operating arc, thereby maintaining the vehicle in a braked condition.

In warehousing applications and particularly stock picking or order filling operations, it is generally desirable to move as much stock as possible, in as little time as possible, and with a minimal amount of labor, such that stock can be delivered with a high degree of efficiency. In such operations, it is desirable for the operator to walk alongside the vehicle when the distance between items of stock to be picked is short, and to ride on the vehicle when the distance is long. Therefore, material handling vehicles used in stock picking operations often have several modes of operation, including a high speed mode for traveling and a “coast” mode in which the vehicle can be operated at a slow speed while the operator walks along the vehicle. In the “coast” mode, the deadman brake is typically overridden, either manually by the operator, or automatically for example as described in U.S. Pat. No. 5,964,313, as it is inefficient to brake the truck and then release the brake each time the operator picks an item of stock.

While “coast” modes are therefore desirable to increase the efficiency of vehicles used in stock picking, there are difficulties associated with coast mode operation. For example, because the deadman braking position can only be visibly differentiated from the “coast” position by the relative position of the handle, it is often difficult for operators to determine whether the vehicle is operating in the high speed mode or the coast mode, and also to determine whether the deadman brake has been activated or not. Therefore, vehicle operators often waste valuable time attempting to disengage the deadman brake, even when it is not engaged, or to increase the speed of the vehicle to travel in the high speed range, even when the vehicle is operating in the coast mode. The inability to determine the operational mode of the vehicle, therefore, causes unnecessary inefficiencies in stock picking and other warehousing operations. This problem is particularly acute for operators who are paid on an incentive basis, and who therefore need to be as efficient as possible.

Another difficulty that operators encounter with the coast mode of operation is being able to access the coast mode actuating device when coast is desired. Frequently, coast mode devices are located in such a way that the operator must either be riding on the platform or walking alongside the vehicle to activate the coast mechanism. Often, therefore, operators are required to switch positions to enter the coast mode, further decreasing the speed and efficiency of the operation.

Therefore, a device that provides a mode of operation indicator is desirable to increase the efficiency of operation of a lift truck, particularly for use in stock picking operations. A device which can be accessed from a number of locations on the lift truck vehicle is also desirable.

### SUMMARY OF THE INVENTION

The present invention is a lift truck including a deadman brake for automatically preventing motion of the lift truck when the operator leaves a driving position. The lift truck includes a coast mode of operation in which a deadman override device prevents automatic engagement of the deadman brake, allowing the lift truck to travel horizontally as the operator walks along side of the vehicle. When in the coast mode of operation, an indicator device is activated to provide a signal to the operator that the deadman brake has been overridden.

A general object of the invention is to provide a control system for a lift truck including a selectively activated coast mode of operation. A mode selector is provided to activate a deadman override device, a speed limiting device, and an indicator device. The deadman override device prevents automatic engagement of the deadman brake when the operator releases the control handle, the speed limiting device limits the maximum speed of the vehicle, and the indicator device provides a signal to the operator that the lift truck is in the coast mode of operation.

Another object of the invention is to provide a lift truck with first and second actuators for engagement of the coast mode of operation. The first and second actuators are located such that they can be activated by an operator from either a riding or a walking position. Each of the actuators cause the lift truck to enter the coast mode of operation in which the deadman override device prevents automatic engagement of the deadman brake, and further limits the speed of the vehicle to a low range of travel speed. When in the coast mode of operation, an indicator device can be activated to provide a signal to the operator that the deadman brake is overridden.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a perspective view of a hand/rider truck;

FIG. 2 is a perspective showing the details of a steering handle for a hand/rider truck;

FIG. 3 is a partial cross-section depicting an embodiment of a deadman override device useful in the present invention;

FIG. 4 is a schematic representation an electrical power circuit for a first embodiment of the present invention; and

FIG. 5 is a schematic representation of an electrical power circuit for a second embodiment of the invention.

### DETAILED DESCRIPTION OF THE INVENTION

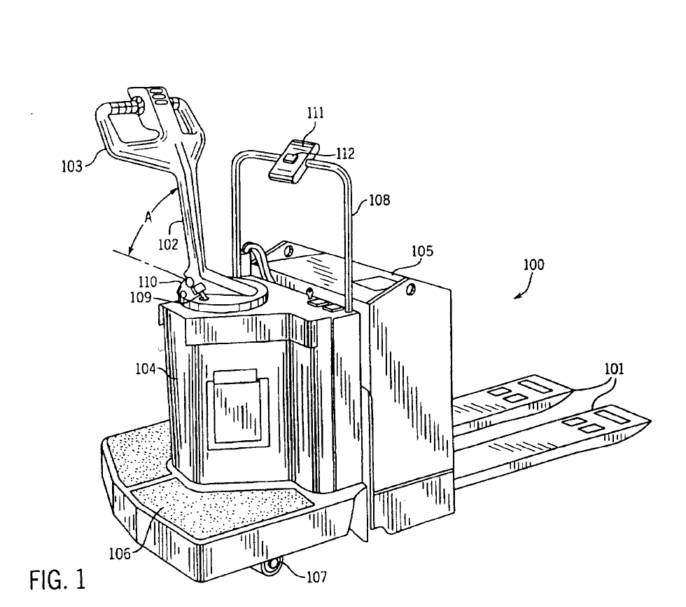

Referring now to the figures and more particularly to FIG. 1, a hand/rider lift truck 100 constructed in accordance with the present invention is shown. The lift truck 100 includes a load bearing fork 101, a traction motor (not shown) enclosed in a motor housing 104, a storage battery (not shown) enclosed in a battery housing 105, and a steerable wheel (not shown) located under a platform 106. The truck 100 is also typically equipped with small stabilizing casters 107 and a hand rail 108 that can be grasped by a riding operator standing in an operator or driver station on the platform 106. The lift truck 100 is driven by a traction drive system including the traction motor and associated traction wheels (not shown), and is steered by a steering control mechanism that includes both a movable steering arm 102 and steering arm handle 103.

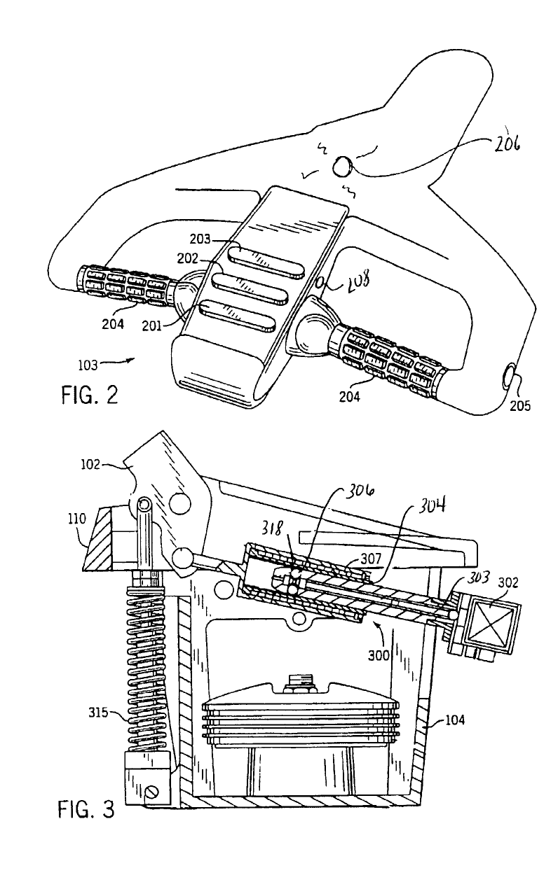

Referring now to FIG. 2, the steering arm handle 103 includes fork control buttons 201 and 202 for lifting and lowering the fork 101 (FIG. 1), respectively; a horn control button 203 for sounding a warning horn (not shown); first and second spring-biased rotatable hand grips 204 for selecting the speed and direction of travel of the truck 100; a jog button 205 and/or a coast engage button 208 for activating a low speed “coast” mode of operation, as described below. The steering arm handle 103 further comprises a mode indicator light 206 which provides a visual indicator of the mode of operation of the lift truck 100 preferably an indication that the deadman brake is overriden, the travel speed command is limited to a low “walking speed,” typically 3.5 mph, and the steering arm 102 is positioned in the driving arc A (FIG. 1), as described below.

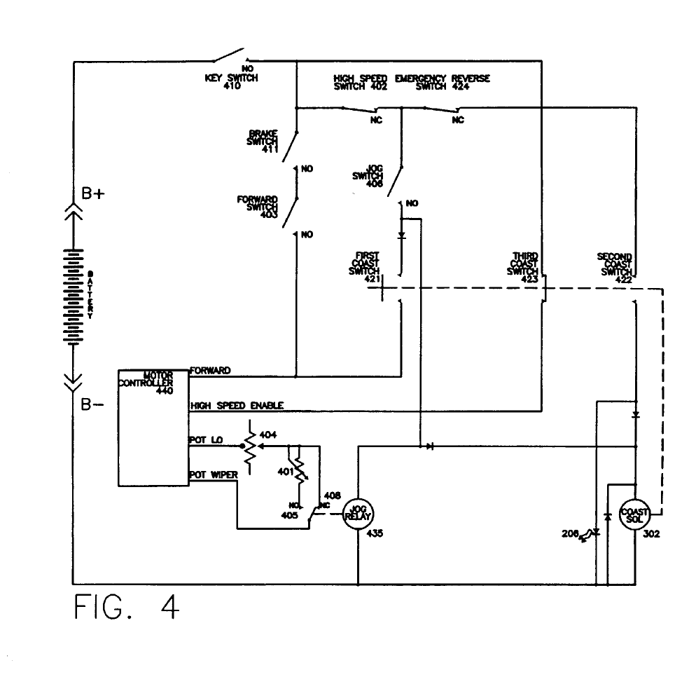

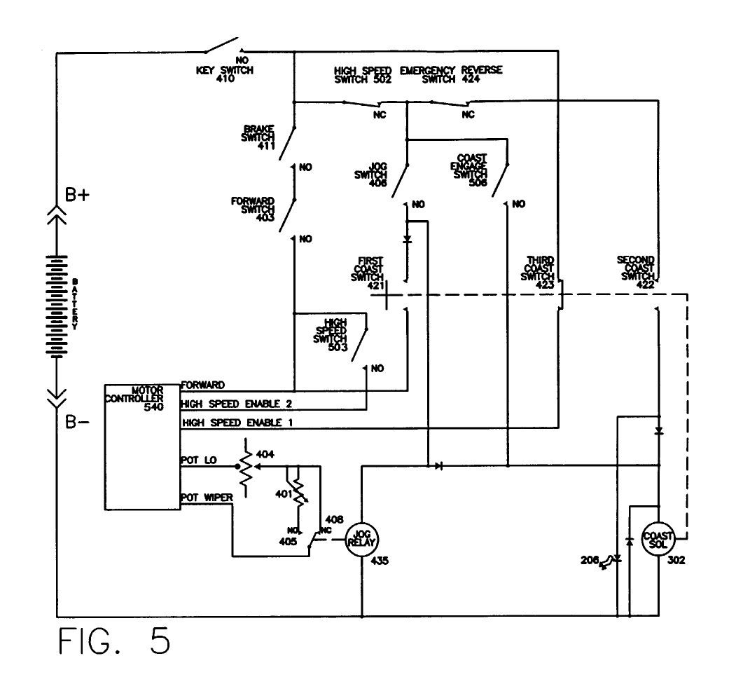

Referring again to FIG. 1, the steering arm 102 is movable up and down through an arc A that ranges from a nearly horizontal (not shown) to a substantially vertical position (FIG. 1). When the arm 102 is positioned in the arc A, power may be delivered to the traction motor and the truck can be driven in either of a forward or a reverse direction, depending on the position of the hand grips 204. When the arm 102 is in either of the substantially horizontal or substantially vertical positions at opposing ends of the arc A, the brake is engaged through a mechanical linkage (not shown), and switch 411 (FIGS. 4, 5) cuts power to the traction motor, preventing further motion of the truck 100 until the arm 102 is forced back into the driving arc A. Braking of the truck 100 can be activated manually, by the operator forcing the arm 102 into one of the substantially horizontal or substantially vertical positions, or automatically by activation of a spring-loaded deadman brake mechanism that drives arm 102 into a braking position when the operator leaves the driving position, particularly when the arm 102 is released by the operator.

The lift truck 100 can be operated in at least two modes: a normal speed mode of operation and a coast mode of operation. Preferably, a third high or maximum speed mode is also provided. In a normal or high speed mode of operation, travel is activated by activating switch 403 (FIGS. 4 and 5), as described below. In this mode of operation, a speed is selected by rotating the hand grip 204, providing a range of speeds between “stop” and a maximum speed of the vehicle. In a “coast” operation mode, travel is activated by activating either the jog button 205 or hand grips 204, as described below. In the coast mode, the speed range of the lift truck 100 is limited to allow motion only at a low rate of speed, such that an operator can walk alongside the vehicle, and a deadman brake override device is activated such that the lift truck 100 can travel horizontally even when the operator releases the handle 102. One method of engaging a coast mode of operation is described below and in U.S. Pat. No. 5,964,313 which is hereby incorporated by reference for its description of an automatic coast device and associated deadman override mechanism. Other methods for mechanically or automatically engaging a deadman override device can also be used.

FIG. 4 is a schematic representation of an electrical power circuit of the lift truck 100 constructed in accordance with a first embodiment of the present invention.

In this embodiment truck travel is enabled by closing key switch 410 and brake switch 411. Moving hand grips 204 (FIG. 2) from their neutral position causes throttle forward command switch 403 to close, here providing a “forward” signal to the motor controller 440 and putting the vehicle in the high speed mode. Speed is controlled by the rotatable hand grips 204 (FIG. 2), which provide a speed control signal to a motor controller 440 through the variable speed control device 404. A high or maximum speed mode can be entered by activating the switch 112 (FIG. 1), which activates a field weakening circuit (not shown) allowing an increase in speed to about 7.5 miles per hour.

When hand grips 204 (FIG. 2) are returned to their neutral position such that throttle forward command switch 403 is open, the lift truck 100 can be put into the coast mode by activating the jog control button 205 (FIG. 2). Jog control button 205 closes jog command switch 406 and actuates both the jog relay 435 and coast solenoid 302. Upon activation of the jog relay 435, normally open contacts 405 close, thereby switching resistor 401 into throttle circuit 404, providing a low speed throttle input to the motor controller 440, and causing the lift truck 100 to travel at a low speed. The coast solenoid 302 closes normally open contacts 421 and 422. Contact 421 provides a “forward motion” signal to the motor controller 440 while contact 422 provides an interlock of the coast solenoid 302, locking the solenoid 302 into an ON position regardless of the position of the jog switch 406 and activates indicator light 206, thereby providing a signal to the operator that the lift truck 100 is being operated in the coast mode and that the deadman brake override is activated, as described below. Activation of the coast solenoid 302 also opens normally closed contact 423, opening the high speed enable line to the motor controller 440, and thereby limiting the motor controller output to a low speed command whenever a throttle input command is generated by moving the twist grips and causing an input from potentiometer 404.

In this embodiment, once the jog button 205 is engaged, either the jog button 205 or the hand grips 204 are used to select a speed between zero and the maximum speed allowed in the low speed state, typically 3.5 miles per hour. Here, the actuation of the high speed button 112 causes normally closed high speed switch 402 to open thereby removing power from coast solenoid 302 causing coast switches 421 and 422 to open and 423 to close and the coast mechanism 300 to disengage. In this embodiment the actuation of solenoid 302 and engagement of the automatic coast control mechanism is maintained until any of the following occur: the operator actuates the high speed control 112, applies the service brake, activates emergency reverse switch 424, (by a control button, not shown); or turns off key switch 410.

Referring now to FIG. 3, activation of the coast solenoid 302 automatically activates the deadman brake override device. With the arm 102 positioned in the arc A coast spring 307 is compressed. Actuation of solenoid 302 urges solenoid stem 303 toward solenoid 302, causing ball detent assembly 306 to engage and constrain slide 304 at a slide detent 318 thereby constraining coast spring 307 when the arm is released by the operator. The force of the compressed coast spring 307 opposes the force exerted by the return spring 315 which is coupled to the steering arm 102 to engage the deadman brake. If the need arises, however, the operator can brake the lift truck 100 to a stop by manually moving the steering arm 102 into the horizontal or vertical braking positions, thereby overriding the operation of the coast control device 300. Operation of the deadman brake override device is described more fully in U.S. Pat. No. 5,964,313, which is incorporated herein by reference for its description of this device. Furthermore, although a specific embodiment of a deadman brake override device is shown, various types of override devices can be used in conjunction with the present system. Other methods for providing a steering arm lock or braking device to override the deadman brake are shown, for example, in U.S. Pat. No. 6,464,025 which is also incorporated herein by reference. Other methods for providing a deadman brake override device will be known to those of skill in the art.

Referring now to FIG. 5, a schematic representation of a second embodiment of an electrical power circuit for the lift truck 100 is shown. Many of the components which form the circuit of FIG. 5 are identical to the components used to form the circuit of FIG. 4, and are therefore identified with identical reference numbers. Different components have been given unique numbers. In this embodiment, the lift truck 100 can again be operated in at least two modes: low speed with coast and normal speed. Preferably, a third high speed mode is also provided, as described below. Here, the low speed coast mode of operation is selectable from each of the jog button, 205, (FIG. 2) and the coast button, 208, (FIG. 2), such that the operator can easily activate the coast mode either from a riding position or a walking position, as described below.

Referring still to FIG. 5, travel can be enabled when an ignition key switch 410 is closed and the deadman brake is released such that brake switch 411 is closed. The normal travel speed is the default mode of operation and occurs when the operator commands either forward or rearward travel by activating the twist grips 204 without activating the jog switch 205 or coast switch 208. Rotating the hand grips 204 closes the throttle switch 403 and provides a “forward” signal to the motor controller 540. Speed is controlled by the rotatable hand grips 204 (FIG. 2), which provide a speed control signal to the motor controller 540 through the variable speed control device or potentiometer 404. In this mode rotation of the twist grips 204 to their maximum position results in a speed of approximately 5.5 mph.

The low speed with coast mode of operation can be activated in two ways in order to allow activation from either the riding position with the operator standing on the platform 106 (FIG. 1) or from the pedestrian position when walking along side the trucks as occurs during order picking. When the steering arm 102 is in the driving arc A, the low speed coast mode can be selected by activating the coast control button 208 (FIG. 2), or by activating the jog button 205 (FIG. 2). Typically, the coast button 208 is used by a rider on the lift truck 100, while a pedestrian activates the job button 205.

Referring still to FIG. 5, to drive the truck in low speed coast mode, the operator pushes the jog button 205 thereby activating switch 406, energizing jog relay 435, closing contact 405, and energizing coast relay 302 and indicator light 206. The normally open contact 405 closes, switching potentiometer 401 into the throttle circuit and providing a throttle input to cause the truck to travel at a low speed of approximately 3.5 miles per hour. Activation of the jog switch 406 also energizes coast solenoid 302 which engages the coast mechanism 300, as described above, closes contacts 421 and 422, and opens contact 423. Normally open contact 422 closes, providing an interlock of the coast solenoid 302 and activates light 206 thereby providing an indication to the operator that the deadman brake override is engaged. Normally open contact 421 closes, enabling forward travel on receipt of a travel command from the jog switch 406. Contact 423 opens thereby preventing a HIGH SPEED ENABLE 1 signal from reaching the motor controller 540 and prohibiting operation in the normal and high speed modes while coast is engaged. Furthermore, whenever the HIGH SPEED ENABLE 1 signal is not activated, the controller 540 limits the maximum speed of the lift truck 100 to a low speed, typically 3.5 miles per hour. Once the jog button 205 is activated, rotating the twist grips 204 will activate the forward switch 403 and provide a throttle input signal to the motor controller 540 from the potentiometer 404, causing the truck to travel at a low speed limited to approximately 3.5 mph. The coast solenoid 302 closes normally open contacts 421 and 422 and opens normally closed contacts 423. Contact 422 provides an interlock of the coast solenoid 302, locking the solenoid 302 into an ON position regardless of the position of the jog switch 406 or the coast engage switch 506.

Alternatively, the coast mode can be selected by activating the coast button 208 (FIG. 2) causing switch 506 to close while the steering arm 102 is in the driving arc A (FIG. 1). Here, the coast solenoid 302 is activated. As described above, normally closed contact 423 opens, preventing entry of a HIGH SPEED ENABLE 1 signal and therefore causing the controller 540 to limit the speed to a selected low speed range, typically 3.5 miles per hour as described above. Normally open contact 422 closes, providing an interlock of the coast solenoid 302, and activates indicator light 206 and normally open contact 421 also closes, enabling forward travel on receipt of a travel command from the jog switch 406 causing the truck to travel in the low speed range.

Regardless of whether the low speed coast mode was selected with the jog button 205 or coast button 208 (FIG. 2), once the coast mode is engaged the steering arm 102 will be restrained within the travel arc A and the deadman brake will not engage as described with reference to FIG. 3. However, the operator can override the coast mechanism and force the steering arm 102 to a substantially vertical or horizontal position outside the travel arc A and cause the brakes to be applied and the truck to come to a stop. The indicator light 206 on the steering arm 103 (FIG. 2) is activated in conjunction with the coast solenoid 302, thereby allowing the operator to easily determine that the lift truck 100 is being operated in the coast mode. Although the indicator light 206 is shown as a light emitting diode, other types of lights such as incandescent light bulbs, LCD displays, and other devices known to those of skill in the art could also be used, as described below.

The high speed travel mode is activated by first placing the truck in the normal travel mode as previously described. With the twist grip 204 fully rotated for maximum speed, pushing on the rabbit or high speed switch 112 (FIG. 1) on the grab bar 108 (FIG. 1) will activate the high speed mode, causing the motor controller 540 to allow travel speed to increase to approximately 7.5 mph. This causes the normally closed contacts 502 of the high speed switch 112 to open thereby prohibiting engagement of the coast mechanism via solenoid 302 and the normally open contacts 503 of one high speed switch to close delivering a high speed request to motor controller 440 and raising the travel speed from approximately 5.5 to 7.5 mph.

In the embodiments of FIGS. 4 and 5 the actuation of coast solenoid 302 and engagement of the automatic coast control mechanism is maintained until any of the following occur: the operator actuates the maximum speed control button 112; actuates emergency reverse switch 424 (by a control button, not shown); or turns off key switch 410.

A mode of operation indicator 206 has been shown as activated in conjunction with the coast mode to provide a signal to the operator indicating that the vehicle has been placed in the “coast” mode of operation, i.e. to indicate that the deadman brake override device has been activated. The indicator 206 has been described here as a light emitting diode (LED). However, the indicator light 206 can be an incandescent lamp or other lighting device. Other types of aural and visual indicators could also be used. For example, the indicator could comprise a horn, musical or other sound producing device. More sophisticated devices including liquid crystal displays (LCD), alphanumeric characters, or plasma displays could also be used. Additionally, although the indicator has been shown to be actuated in conjunction with the coast mode of operation, one or more indicators could also be activated in conjunction with the normal or high speed modes of operation. Furthermore, rather than activating the indicator 206 when the coast mode is activated, the indicator 206 could be activated to indicate that the coast mode is not active. Furthermore, although the indicator 206 has been shown for use with an automatic coast mode, the coast mode indicator device 206 can be used in conjunction with both manual and automated deadman override devices.

Although preferred speed levels and mode have been described, the operational speed of the lift truck can be provided at any level. Preferably, the speed of the vehicle in coast mode is maintained at a “walking” speed or approximately 3.5 mph in accordance with current regulations. However, this speed level can be altered as required or desirable. The range of speeds in the low speed mode is typically lower than that in the normal speed mode, and the normal speed mode is typically less than the high or maximum speed mode. However, the speed ranges associated with each of these modes can be varied. For example, the coast mode and the normal mode can be provided with the same defined speed range.

Additionally, although specific embodiments of control systems have been shown and described, the combined system for activating a coast mode in conjunction with an indicator light can be varied. For example, the coast mode device can be activated with a specific coast mode activator, actuator, as part of a jog switch or in conjunction with a speed selection. Additionally, the coast and jog buttons can be used in conjunction with other controls, including various motion and speed controls, to provide the coast and jog functions in various ways, and to provide travel in various speed ranges. For example, activation of the jog button can be used to activate the vehicle, or to set up the coast mode while activation of the vehicle is provided by another control such as a twist or hand grip and/or an associated switch. Furthermore, although jog and coast switches or activators have been shown in specific locations, the jog and coast buttons can be provided in various locations on the lift truck 100.

Additionally, although the deadman braking device of the present invention has been shown as activated by the steering mechanism, similar devices such as deadman braking systems operated by floor switches or other types of sensor devices which activate a deadman brake when the operator leaves an operator station could also be used.

The invention has been described in detail with particular reference to certain preferred embodiments thereof, but it will be understood that variations and modifications can be effected within the spirit and scope of the invention.

I claim:

1. A lift truck, comprising:
an operator station from which the operator drives the lift truck;
a steering mechanism provided in the operator station and controlled by the operator to select a direction of motion;
a traction system controlled by the operator to drive the lift truck in a selected direction;
a deadman brake coupled to the traction system to prevent motion of the lift truck when the operator leaves the operator station;
a deadman lockout device coupled to the deadman brake for providing a coast mode of operation in which the deadman brake is prevented from automatically engaging; and
an indicator device activated when the lift truck is in the coast mode of operation to provide a signal to the operator that the deadman lockout device is active.

2. The lift truck as defined in claim 1, wherein the indicator device is an indicator light.

3. The lift truck as defined in claim 1, wherein the indicator device is an audio device.

4. The lift truck as defined in claim 1, wherein the indicator device is an light emitting diode.

5. The lift truck as defined in claim 1, further comprising a steering arm coupled to the brake to activate the brake when the steering arm is moved outside of a defined arc of operation.

6 The lift truck as defined in claim 1 further comprising a control circuit for selecting a speed of motion of the lift truck and for limiting the speed of operation of the lift truck when the lift truck is in the coast mode of operation.

7. The lift truck as defined in claim 6, wherein the control circuit includes an activator for selecting the coast mode of operation.

8. The lift truck as defined in claim 5, wherein the indicator device is coupled to the steering arm.

9. The lift truck as defined in claim 7, wherein the activator is a jog button.

10. The lift truck as defined in claim 7, wherein the activator is a coast button.

11. The lift truck as defined in claim 6, wherein the control circuit includes a jog button and a coast button, and the coast mode of operation is selected by activating either of the coast or the job buttons.

12. A control system for driving a lift truck, comprising:
a traction system;
a deadman brake coupled to the traction system and activated to prevent motion of the lift truck when the operator leaves a driving position;
a deadman override device coupled to the deadman brake for preventing automatic engagement of the deadman brake;
a variable speed control device electrically coupled to the traction system to set a speed of the lift truck;
a mode selector device coupled to the variable speed control device and to the deadman override device to selectively limit the speed of the lift truck and to activate the deadman override device to provide a coast mode of operation; and
an indicator device activated by the mode selector device to provide a signal to the operator when the lift truck is in the coast mode of operation.

13. The control system as defined in claim 12, further comprising a steering arm coupled to the deadman such that the deadman brake operates when the steering arm is moved outside of a driving arc.

14. The control system as defined in claim 13, wherein the indicator device is coupled to the steering arm.

15. The control system as defined in claim 13, wherein the mode select device is coupled to the steering arm.

16. The control system as defined in claim 12, wherein the mode select device comprises a momentary switch button and a control relay, the momentary switch button activating the control relay.

17. The control system as defined in claim 16, wherein the control relay is locked into an active mode until the coast mode is disabled.

18. The control system as defined in claim 17, wherein the indicator device is activated in conjunction with the control relay.

19. The control system as defined in claim 12, wherein the indicator device is a light.

20. The control system as defined in claim 12, wherein the indicator device is a light emitting diode.

21. The control system as defined in claim 12, wherein the indicator device is a sound producing device.

22. The control system as defined in claim 12, wherein the deadman brake is activated by a floor switch.

23. The control system as defined in claim 16, wherein the control relay activates the deadman override device.

24. A lift truck, comprising:
an operator station from which the operator drives the lift truck;
a steering mechanism provided in the operator station and controlled by the operator to select a direction of motion;
a traction system controlled by the operator to drive the lift truck in a selected direction;
a deadman brake coupled to the traction system to prevent motion of the lift truck when the operator leaves the operator station;
a deadman lockout device coupled to the deadman brake for providing a coast mode of operation in which the deadman brake is prevented from automatically engaging;
a first actuator for activating the coast mode of operation, the first actuator being located within reach of the operator on the operator station; and
a second actuator for activating the coast mode of operation, the second actuator being located within reach of the operator as the operator walks alongside the vehicle.

25. The lift truck as defined in claim 24, further comprising an indicator device activated when the lift truck is in the coast mode of operation to provide a signal to the operator that the lift truck is in the coast mode of operation.

26. The lift truck as defined in claim 24, wherein the speed of the lift truck is limited to a selected speed range lower than a normal speed range of the lift truck.

27. A control system for driving a lift truck, comprising:
a traction system;
a deadman brake coupled to the traction system and activated to prevent motion of the lift truck when the operator leaves a driving position;
a deadman override device coupled to the deadman brake for preventing automatic engagement of the deadman brake;
a variable speed control device electrically coupled to the traction system to set a speed of the lift truck;
a first and a second actuator device coupled to the variable speed control device and to the deadman override device, each of the first and second actuator devices selectively limiting the speed of the lift truck and activating the deadman override device to provide a coast mode of operation; and
an indicator device activated by each of the first and second actuator devices to provide a signal to the operator when the lift truck is in the coast mode of operation.
